(19) United States
(12) Patent Application Publication
(10) Pub. No.: US 2010/0307906 A1
(43) Pub. Date: Dec. 9, 2010

(54) CONNECTION WIRE FOR SERIAL PORT

(75) Inventor: Ying-Chuan Tsai, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/510,281

(22) Filed: Jul. 28, 2009

(30) Foreign Application Priority Data
Jun. 8, 2009 (CN) 200910303042.1

(51) Int. Cl. H01H 13/70

(52) U.S. Cl. 200/5 R

(57) ABSTRACT

A connection wire for a serial port comprises a first electrical connector, a second electrical connector, and a double pole double throw switch. The first electrical connector comprises a first transmit-data pin, a first receive-data pin, and a first ground pin. The second electrical connector comprises a second transmit-data pin, a second receive-data pin and a second ground pin. The double pole double throw switch comprises a first pole, a second pole, a first throw, a second throw, a third throw and a fourth throw. The first pole is configured to be connected to the first transmit-data pin, the second pole is configured to be connected to the first receive-data pin; the first and the fourth throws are configured to be connected to the second receive-data pin, and the second and the third throws are configured to be connected to the second transmit-data pin of the serial port transmission line. The first ground pin is configured to be connected to the second ground pin.

### BACKGROUND

1. Technical Field

The present application is related to connection wires, and particularly to connection wires for serial ports.

2. Description of Related Art

Serial ports are commonly used as a serial communication standard for asynchronous start-stop communication, such as for computer terminals, modems, printers, and other devices. Data transmission between two devices, such as from a computer terminal to a peripheral device, requires crossover connection to transmit data; that is, a transmit-data pin of one device is connected to a receive-data pin of another device. However, connection wires may not be long enough to connect two devices, and an extension of the connection wires is often needed. The extension needs parallel connection, a transmit-data pin of one electrical connector connecting to a transmit-data pin of another electrical connector. Accordingly, two kinds of connection wires, crossover and parallel, are needed for data transmission. However, these two different kinds of connection wires have similar appearance, and visually distinguishing between the two is difficult. Therefore, preparing the two kinds of wires to satisfy different connection requirements causes inconvenience and increases costs.

### BRIEF DESCRIPTION OF THE DRAWINGS

FIG. 1 is a schematic drawing showing one embodiment of the connection wires for serial ports as disclosed.

FIG. 2 is a schematic drawing showing the connection wires for serial ports as disclosed, realized in an electrical connector conforming to RS-232 protocol.

### DETAILED DESCRIPTION

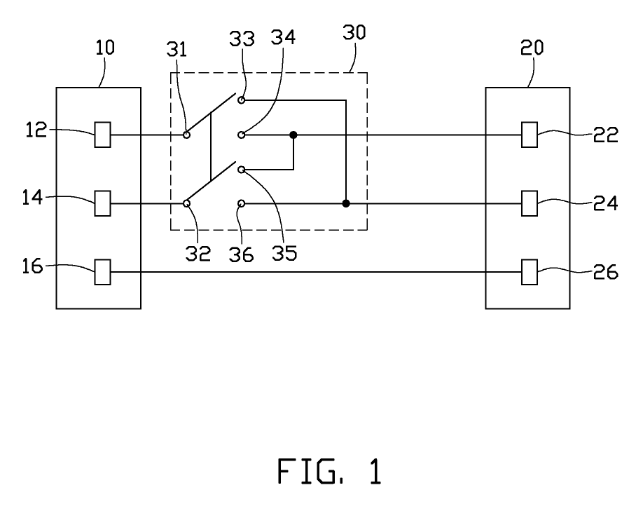

FIG. 1 illustratively shows a serial port connection wire as disclosed. The serial port connection wire comprises an electrical connector 10 comprising a transmit-data pin 12, a receive-data pin 14, and a grounding pin 16; and an electrical connector 20 comprising a transmit-data pin 22, a receive-data pin 24, and a ground pin 26. The serial port connection wire also comprises a double pole double throw (DPDT) switch 30 comprising a first pole 31, a second pole 32, a first throw 33, a second throw 34, a third throw 35, and a fourth throw 36. The transmit-data pin 12 is connected to the first pole 31, and the receive-data pin 14 is connected to the second pole 32. The transmit-data pin 22 is connected to the second throw 34 and the third throw 35, and the receive-data pin 24 is connected to the first throw 33 and the fourth throw 36. The ground pin 16 is connected to the grounding pin 26.

When the first and the second poles 31 and 32 of the DPDT switch 30 are turned to be connected to the first and third throws 33 and 35, respectively, the transmit-data pin 12 and the receive-data pin 14 of the electrical connector 10 are connected to the receive-data pin 24 and the transmit-data pin 22 correspondingly. The serial port connection wire now is configured as a crossover connection. When the first and the second poles 31 and 32 of the DPDT switch 30 are turned to be connected to the second and fourth throws 34 and 36 respectively, the transmit-data pin 12 and the receive-data pin 14 of the electrical connector 10 are connected to the transmit-data pin 22 and the receive-data pin 24 correspondingly, such that the serial port connection wire is configured as a parallel connection.

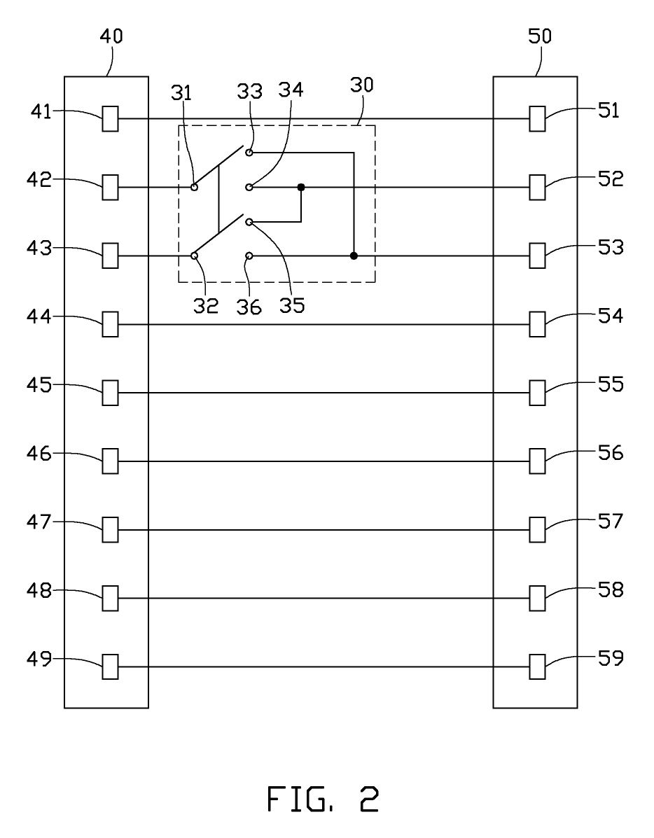

FIG. 2 illustratively shows a serial port connection wire compliant with RS-232 standard. The serial port connection wire comprises two electrical connectors 40 and 50 compliant with RS-232 standard, and the DPDT switch 30. The electrical connector 40 comprises a data-carrier-detect pin 41, a receive-data pin 42, a transmit-data pin 43, a data-terminal-ready pin 44, a signal-ground pin 45, a data-set-ready pin 46, a request-to-send pin 47, a clear-to-send pin 48, and a ring-indicator pin 49. The electrical connector 50 comprises a data-carrier-detect pin 51, a receive-data pin 52, a transmit-data pin 53, a data-terminal-ready pin 54, a signal-ground pin 55, a data-set-ready pin 56, a request-to-send pin 57, a clear-to-send pin 58, and a ring-indicator pin 59. The receive-data pin 42 and the transmit-data pin 43 are correspondingly connected to the first and second poles 31 and 32, the receive-data pin 52 are connected to the second and third throws 34 and 35, and the transmit-data pins 53 are connected to the first and fourth throws 33 and 36.

When the first and second poles 31 and 32 of the DPDT switch 30 are connected to the first and third throws 33 and 35, the connection wire is configured as a crossover connection. When the first and second poles 31 and 32 of the DPDT switch 30 are connected to the second and fourth throws 34 and 36, the connection wire is configured as a parallel connection.

The present application also can be applied to connection wires for other standard communication protocols, such as TIA/EIA-568A standard, TIA/EIA-568B standard, or mixing of TIA/EIA-568A and EIA/TIA568-B standards. The double pole double throw switch can be applied between the transmit-data pins and the receive-data pins accordingly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A serial port connection wire, comprising:
a first and a second electrical connectors, the first electrical connector comprising a first transmit-data pin, a first receive-data pin, and a first ground pin, the second electrical connector comprising a second transmit-data pin, a second receive-data pin and a second ground pin;
a double pole double throw switch, comprising a first and a second poles, and a first, a second, a third and a fourth throws, wherein the first pole is configured to be connected to the first transmit-data pin, the second pole is configured to be connected to the first receive-data pin; the first and the fourth throws are configured to be connected to the second receive data pin, and the second and the third throws are configured to be connected to the second transmit data pin of the serial port connection wire;
wherein the first ground pin is configured to be connected to the second ground pin.

2. The connection wire as claimed in claim 1, wherein the first and the second electrical connectors are compliant with RS-232 communication standard, and wherein the connection wire is compliant with RS-232 standard, TIA/EIA-568A standard, TIA/EIA-568B standard, or the mixing of TIA/EIA-568A and TIA/EIA-568B standard.

3. A double pole double throw switch used in connection wire for a serial port, the connection wire comprising a first transmit-data pin, a first receive-data pin, a first ground pin, a second transmit-data pin, a second receive-data pin, and a second ground pin, the double pole double throw switch comprising:
a first and a second poles;
a first, a second, a third and a fourth throws;
wherein the first and the fourth throws are connected together, and the second and the third throws are connected together.

4. The double pole double throw switch as claimed in claim 3, wherein the first pole is connected to the first transmit-data pin, the second pole is connected to the first receive-data pin, the first and the fourth throws are connected to the second receive-data pin, and the second and the third throws are connected to the second transmit-data pin.

5. The double pole double throw switch as claimed in claim 3, wherein the connection wire is compliant with RS-232 standard, TIA/EIA-568A standard, TIA/EIA-568B standard, or the mixing of TIA/EIA-568A and TIA/EIA-568B standard.
